(19) United States
(12) Patent Application Publication
(10) Pub. No.: US 2005/0281461 A1
(43) Pub. Date: Dec. 22, 2005

(54) Motion-based image segmentor

(76) Inventors: Michael Edward Farmer, W. Bloomfield, MI (US); Shweta Roshan Bapna, Rochester Hills, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/870,830

(22) Filed: Jun. 16, 2004

(51) Int. Cl. G06K 9/00

(52) U.S. Cl. 382/171

(57) ABSTRACT

The present invention relates in general to systems and methods for using motion-based information to segment an image. In particular, the present invention relates to using a joint histogram to isolate a motion-based information of a moving person or object from an “ambient image” of the area surrounding and including the person or object in motion. An exemplary method or system for segmenting an image may include the steps of: generating a joint histogram of a first image and a second image; using the joint histogram to identify motionless information representative of a lack of motion between the first image and the second image; and removing the motionless information from the second image.

### RELATED APPLICATIONS

The contents of the following applications are hereby incorporated by reference in their entirety: “A RULES-BASED OCCUPANT CLASSIFICATION SYSTEM FOR AIRBAG DEPLOYMENT,” Ser. No. 09/870,151, filed on May 30, 2001; “IMAGE PROCESSING SYSTEM FOR DYNAMIC SUPPRESSION OF AIRBAGS USING MULTIPLE MODEL LIKELIHOODS TO INFER THREE DIMENSIONAL INFORMATION,” Ser. No. 09/901,805, filed on Jul. 10, 2001; “IMAGE PROCESSING SYSTEM FOR ESTIMATING THE ENERGY TRANSFER OF AN OCCUPANT INTO AN AIRBAG,” Ser. No. 10/006,564, filed on Nov. 5, 2001; “IMAGE SEGMENTATION SYSTEM AND METHOD,” Ser. No. 10/023,787, filed on Dec. 17, 2001; and “IMAGE PROCESSING SYSTEM FOR DETERMINING WHEN AN AIRBAG SHOULD BE DEPLOYED,” Ser. No. 10/052,152, filed on Jan. 17, 2002; “MOTION-BASED IMAGE SEGMENTOR FOR OCCUPANT TRACKING,” Ser. No. 10/269,237, filed on Oct. 11, 2002; “OCCUPANT LABELING FOR AIRBAG-RELATED APPLICATIONS,” Ser. No. 10/269,308, filed on Oct. 11, 2002; “MOTION-BASED IMAGE SEGMENTOR FOR OCCUPANT TRACKING USING A HAUSDORF-DISTANCE HEURISTIC,” Ser. No. 10/269,357, filed on Oct. 11, 2002; “SYSTEM OR METHOD FOR SELECTING CLASSIFIER ATTRIBUTE TYPES,” Ser. No. 10/375,946, filed on Feb. 28, 2003; “SYSTEM AND METHOD FOR CONFIGURING AN IMAGING TOOL,” Ser. No. 10/457,625, filed on Jun. 9, 2003; “SYSTEM OR METHOD FOR SEGMENTING IMAGES,” Ser. No. 10/619,035, filed on Jul. 14, 2003; “SYSTEM OR METHOD FOR CLASSIFYING IMAGES,” Ser. No. 10/625,208, filed on Jul. 23, 2003; “SYSTEM OR METHOD FOR IDENTIFYING A REGION-OF-INTEREST IN AN IMAGE,” Ser. No. 10/663,521, filed on Sep. 16, 2003; “DECISION ENHANCEMENT SYSTEM FOR A VEHICLE SAFETY RESTRAINT APPLICATION,” Ser. No. 10/703,345, filed on Nov. 7, 2003; “DECISION ENHANCEMENT SYSTEM FOR A VEHICLE SAFETY RESTRAINT APPLICATION,” Ser. No. 10/703,957, filed on Nov. 7, 2003; “METHOD AND SYSTEM FOR CALIBRATING A SENSOR,” Ser. No. 10/662,653, filed on Sep. 15, 2003; and “SYSTEM OR METHOD FOR CLASSIFYING TARGET INFORMATION CAPTURED BY A SENSOR,” Ser. No. 10/776,072, filed on Feb. 11, 2004.

### BACKGROUND OF THE INVENTION

The present invention relates in general to systems and methods for segmenting an image using motion-based information. In particular, the systems and methods relate to using a joint histogram to isolate motion-based information of a moving person or object from an “ambient image” of the area surrounding and including the person or object in motion.

There are many situations in which it may be desirable to isolate the “segmented image” of a “target” person or object from an “ambient image” which includes the image area surrounding the “target” person or object. In some situations, the speed and accuracy at which the segmented image can be isolated is crucial. Airbag deployment applications are one prominent example of environments in which images should be segmented quickly and accurately so that appropriate deployment decisions can be made.

Airbags provide a significant safety benefit for vehicle occupants in many different situations. However, in some situations, the deployment of an airbag is not desirable. For example, the seat corresponding to the deploying airbag might be empty, rendering the deployment of the airbag an unnecessary hassle and expense. Deployment of the airbag can also cause harm to certain types of vehicle occupants, including infants and small children. Airbag deployment may also be undesirable if the occupant is too close to the airbag, e.g., within an at-risk zone. Thus, even within the context of a particular occupant, deployment of the airbag is desirable in some situations (e.g., when the occupant is not within the at-risk zone), while not desirable in other situations (e.g., when the occupant is within the at-risk zone).

Some airbag deployment applications segment images to help determine an appropriate deployment action based on an estimated position of a vehicle occupant. These applications should segment the image accurately and timely. However, conventional segmentation systems face a number of significant obstacles to the accurate and timely segmentation of images. Because automated image processing techniques are not as adept as the human mind at making accurate conclusions about a particular image, image segmentation systems typically have a much harder time accurately interpreting the characteristics of an image. For example, many conventional image segmentation systems tend to inadequately distinguish motion of a target person or object from illumination changes in an ambient image. In the context of an airbag deployment application, a mistake between luminosity changes and motions of the occupant of the vehicle can cause the position of the occupant to be incorrectly estimated, which may result in an erroneous, and potentially hazardous, airbag action.

Another obstacle to the accurate and timely segmentation of images occurs when images are to be segmented in high-speed environments, such as when a vehicle undergoes severe pre-crash braking. Typical image segmentation systems have not kept pace with the speeds at which images can be captured. For example, a standard video camera typically captures about forty frames of images each second. Some airbag deployment applications incorporate sensors that capture images at even faster rates than a standard video camera. Unfortunately, the rapid capture of images cannot assist an airbag deployment application if segmentation of the images does not keep pace with the rate at which ambient images are captured. An airbag deployment application can be only as fast as its slowest requisite process step.

Many typical image segmentation systems rely on techniques that act as a bottleneck to airbag deployment applications. For example, conventional image segmentation systems typically rely on the processing of actual images. The convention segmentation systems may rely on template matching from frame-to-frame or estimating the optical flow of grayscale values. In the context of an airbag deployment application, such constraints on speed can lead to erroneous estimations at instances when correct action by the airbag deployment application is especially important.

### SUMMARY OF THE INVENTION

The present invention relates in general to systems and methods for using motion-based information to segment an image. In particular, the present invention relates to using a joint histogram to isolate a motion-based information of a moving person or object from an “ambient image” of the area surrounding and including the person or object in motion.

An exemplary method for segmenting an image may include: generating a joint histogram of a first image and a second image; using the joint histogram to identify motionless information representative of a lack of motion between the first image and the second image; and removing the motionless information from the second image.

An exemplary image segmentation system may include: a histogram module providing for generating a joint histogram of a first image and a second image, wherein the joint histogram indicates motionless information representative of a lack of motion between the first image and the second image; and a removal module providing for removing the motionless information indicated by the joint histogram from the current image.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a partial view illustrating an example of an image segmentation system in a vehicle safety restraint application embodiment.

FIG. 2 shows a high-level process flow diagram illustrating an example of the image segmentation system of FIG. 1 in the context of a safety restraint deployment application embodiment.

FIG. 3 is a flow chart illustrating an example of a safety restraint deployment application having an image segmentation process.

FIG. 4 is a flow chart illustrating an example of the image segmentation process of FIG. 3.

FIG. 5 is an example of an ambient image that can be acquired by the image segmentation process.

FIG. 6 is an example of a joint histogram of pixel characteristics for the ambient image of FIG. 5 compared with itself.

FIG. 7A is an example of an ambient image to be used with another ambient image to generate a joint histogram.

FIG. 7B is an example of an ambient image to be used with the ambient image of FIG. 7A to generate a joint histogram.

FIG. 8A is a difference image of the ambient images of FIGS. 7A-B.

FIG. 8B is a joint histogram of the ambient images of FIGS. 7A-B.

FIG. 9A is an example of a joint histogram for an image compared with a version of itself having additive illumination.

FIG. 9B is an example of a joint histogram for an image compared with a version of itself having multiplicative illumination.

FIG. 9C is an example of a joint histogram for an image compared with a version of itself having only a region with multiplicative illumination.

FIG. 10 is an image having an exemplary ellipse fitted about an occupant area.

### DETAILED DESCRIPTION OF A PREFERRED EMBODIMENT

The present invention relates in general to systems and methods for using motion-based information to segment an image. In particular, the present invention relates to using a joint histogram to isolate motion-based information of a moving person or object from an “ambient image” of the area surrounding and including the person or object in motion.

The present systems and methods can isolate motion-based information of the moving person or object by generating a joint histogram of at least two captured images, which images are representative of the person or object and the surrounding area. The joint histogram is used to identify and remove motionless data from at least one of the images, preferably from the more recently acquired image. Motionless data or information can be referred to as mutual information, which should be understood as data that has not changed beyond some threshold between the two images. In other words, mutual information includes data values shared by the two images. More specifically, mutual information can be defined to include generally congruent pixel values that are shared by spatially corresponding pixels of the two images.

Mutual information shared between a spatially corresponding pixel pair is representative of a lack of motion during the time interval between acquisition of the images being compared. Thus, mutual information is useful for identifying a lack of motion of a person or object between the compared images. After identifying mutual information of the compared images, the present systems and methods can remove the mutual information from at least one of the images to allow further processing of that image to focus on processing only areas affected by motion. This will be discussed in greater detail below.

I. Partial View of Surrounding Environment

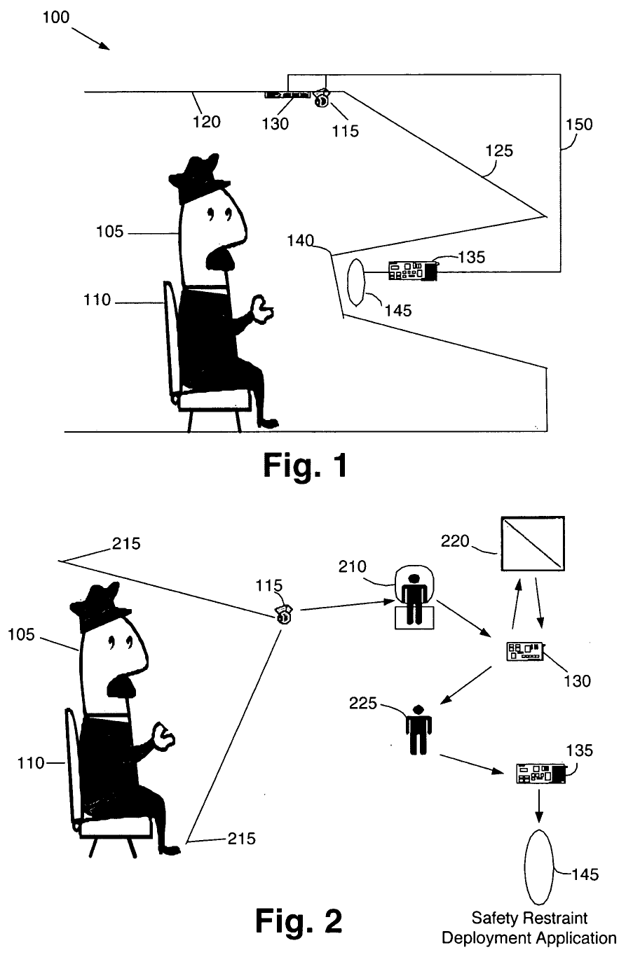

Referring now to the drawings, FIG. 1 is a partial view of an environment for potentially many different embodiments of an image segmentation system 100 (also referred to as “the system 100”). If an occupant 105 is present, the occupant 105 can sit on a seat 110. A video camera or any other sensor capable of rapidly capturing images (collectively “sensor” 115) can be attached at an appropriate position for capturing images illustrative of the position of the occupant 105. For example, the sensor 115 may be positioned in a roof liner 120, above the occupant 105 and closer to a front windshield 125 than the occupant 105. The sensor 115 can be placed at a slightly downward angle towards the occupant 105 in order to capture changes in the angle of the occupant's 105 upper torso resulting from forward or backward movement in the seat 110. There are many potential locations for the sensor 115 that are known in the art.

A wide range of different sensors 115 can be used by the system 100 to acquire images tending to illustrate the position of the occupant 105 relative to the vehicle. For example, the sensor 115 may comprise a standard video camera that typically captures approximately forty frames of images per second. Higher and lower speed sensors 115 can be used by the system 100.

A computer, computer network, or any other computational device or configuration capable of implementing a process or running a computer program (collectively “computer system” 130 or “computer” 130) can house image segmentation logic. The computer 130 can be any type of processor or device capable of performing the segmentation process described below. The computer 130 can be located virtually anywhere in or on a vehicle. Preferably, the computer 130 is located near the sensor 115 to avoid sending images through long wires.

A safety restraint controller 135 is shown in a dashboard 140. However, the system 100 can still function even if the safety restraint controller 135 were located at a different position. The safety restraint controller 135 may be configured to help analyze information obtained from the acquired images. The safety restraint controller 135 can then send analysis information to a safety restraint deployment application 145 (also referred to as “deployment application” 145). The deployment application 145 can make a deployment decision based on the analysis of information obtained from the acquired images. In some embodiments, the safety restraint controller 135 is part of the computer 130.

As shown in FIG. 1, the safety restraint deployment application 145 can be located in the dashboard 140. However, it is anticipated that the system 100 can function with deployment applications 145 positioned at alternative locations, such as in a vehicle door panel. In a preferred embodiment, the safety restraint deployment application 145 comprises an airbag deployment mechanism. The deployment application 145 should be configured to make a deployment decision based on information received from the safety restraint controller 135. The system 100 can be flexibly implemented to incorporate future changes in the design of vehicles and safety restraint deployment applications 145.

As shown in FIG. 1, a communications network 150 can provide for communications between the sensor 115, the computer 130, the airbag controller 135, and the safety restraint deployment application 145. The communication network 150 may comprise any components helpful for facilitating electronic communications, including wireless and/or wire-line communications.

II. High-Level Process Flow for Safety Restraint Deployment

FIG. 2 shows a high-level process flow diagram illustrating an example of the image segmentation system 100 in the context of a safety restraint deployment application embodiment. The sensor 115 can capture an ambient image 210 representative of an image source area 215. The image source area 215 includes both the occupant 105 and surrounding seat area. In FIG. 2, the image source area 215 includes the entire occupant 105, although under many different circumstances and embodiments, only a portion of the occupant's 105 image will be captured, particularly if the sensor 115 is positioned in a location where the lower extremities may not be viewable.

The ambient image 210 can be sent to the computer 130 for processing. In particular, the computer 130 can generate and use a joint histogram 220 to isolate motion-based information from the ambient image 210. The joint histogram 220 allows the computer 130 to easily distinguish motion-based information from other types of information in the ambient image 210. The system 100 can focus on the motion-based information without becoming confused by different types of information contained in the ambient image 210.

By isolating the motion-based information from the ambient image 210, the computer 130 can generate a segmented image 225. The segmented image 225 includes portions of the ambient image 210 that have been isolated from the ambient image 210 as a whole. Preferably, these isolated portions represent motion-based information. The joint histogram 220 and an exemplary process by which the system 100 performs image segmentation will be described below.

The segmented image 225 can be analyzed to determine an appropriate safety restraint deployment decision. For example, the safety restraint deployment application 145 may use the segmented image 225 to track or estimate and predict characteristics of the occupant 105 such as position, motion, velocity, acceleration, etc. The predicted characteristics of the occupant 105 can then be used to make a deployment decisions. The computer 130, the safety restraint controller 135, and/or the deployment application 145, alone or in combination, can analyze the segmented image 225 to make a deployment decision. Preferably, the deployment decisions are made based on real-time occupant 105 characteristics. Techniques for using segmented images 225 to track occupant characteristics are described in some of the references that have been incorporated by reference in their entirety.

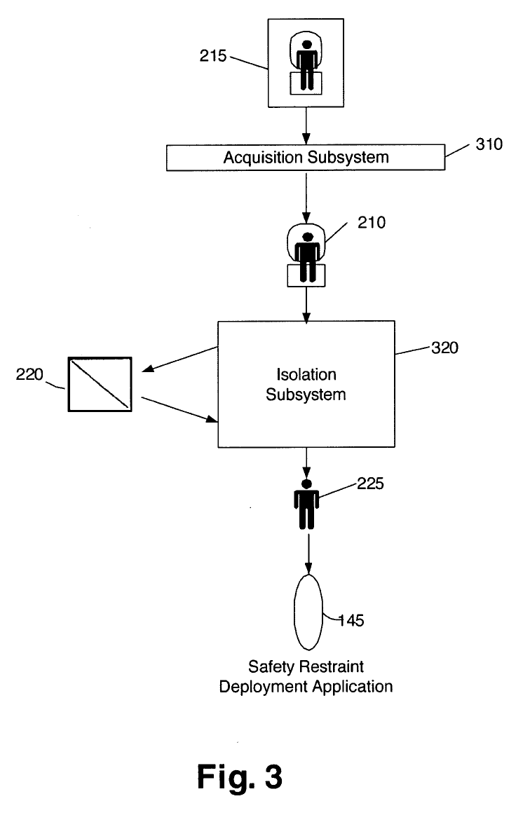

FIG. 3 illustrates a subsystem-level view of an exemplary image segmentation system 100 implemented in a safety restraint deployment application embodiment. This process may continuously repeat so long as the occupant 105 is in the vehicle or the vehicle is operating. As shown in FIG. 3, the ambient image 210 representative of the image source area 215 can be captured by an acquisition subsystem 310. The acquisition subsystem 310 may acquire a number of sequentially collected ambient images 210, including a continuous stream of ambient images 210. The acquisition subsystem 310 can include the sensor 115 described above for capturing the ambient images 210.

The ambient image 210 can be represented by one or more pixels. As a general matter, the greater the number of pixels in the ambient image 210, the better the resolution of the image 210. In a preferred embodiment, the width of the ambient image 210 should be at least approximately 400 pixels across, and the ambient image 210 should be at least approximately 300 pixels in height. If there are too few pixels, it can be difficult to isolate the segmented image 225 from the ambient image 210. The number of pixels is dependent upon the type and model of sensor 115, and sensors 115 generally become more expensive as the number of pixels increases. A standard video camera can capture an image roughly 400 pixels across and 300 pixels in height. Such an embodiment captures a sufficiently detailed ambient image 210 while remaining relatively inexpensive because a standard non-customized sensor 115 can be used. Thus, a preferred embodiment will use approximately 120,000 (400×300) total pixels to represent the ambient image 210.

Each pixel can possess one or more different pixel characteristics. The system 100 may use any of the pixel characteristics to isolate the segmented image 225 from the ambient image 210. Pixel characteristics may include but are not limited to color values, grayscale values, brightness density values, luminosity values, gradient values, location addresses, heat values, a weighted combination of two or more characteristics, and any other characteristic that could potentially be used to segment an image.

Each pixel characteristic can be represented by one or more pixel values. For example, the pixel characteristic of grayscale luminosity can be represented with a numerical pixel value between 0 (darkest possible luminosity) and 255 (brightest possible luminosity). A particular pixel characteristic can be measured, stored, and manipulated as a pixel value relating to the particular pixel.

The acquisition subsystem 310 can send the ambient image 210 to an isolation subsystem 320. Upon receipt of the ambient image 210, the isolation subsystem 320 can then use the joint histogram 220 to isolate the segmented image 225 from the ambient image 210. The process by which the isolation subsystem 320 performs image segmentation will be described below. In some embodiments, the isolation subsystem 320 is part of the computer 130. The segmented image 225 is made available to the safety restraint deployment application 145 for predicting the position characteristics of the occupant 105 to use in making deployment decisions as mentioned above.

III. Image Isolation Subsystem and Process

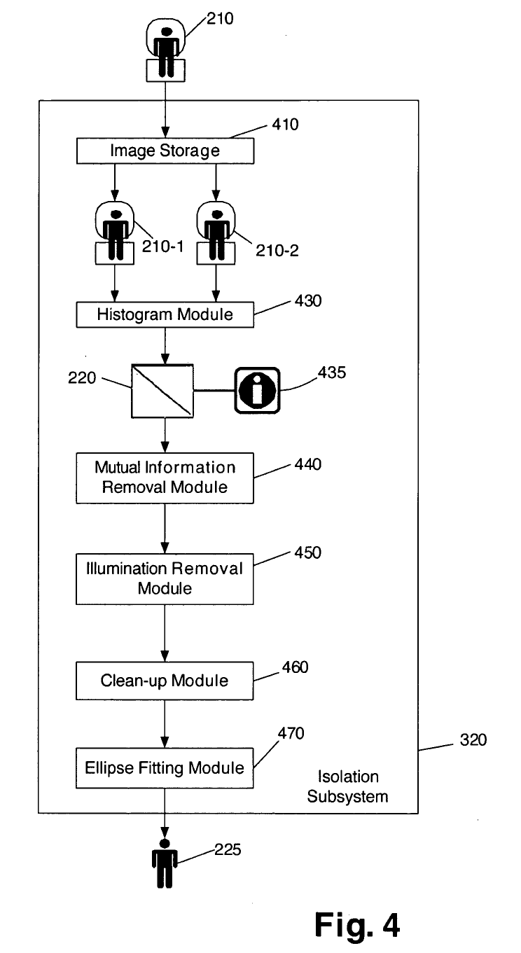

FIG. 4 illustrates an example of an image segmentation process that can be implemented by the isolation subsystem 320. The isolation subsystem 320 is flexible, and can incorporate a wide variety of different variations to the processes disclosed in FIG. 4. Some embodiments may apply fewer process steps while others will add process steps. In a preferred embodiment, each ambient image 210 captured by the sensor 115 can be subjected to a segmentation process, such as the process illustrated in the figure.

A. Current Image and Previous Image

As mentioned above, the ambient images 210 can be acquired as a stream of images. Accordingly, the ambient images 210 represent images of the source area 215 at different times. The isolation subsystem 320 can compare multiple ambient images 210 to identify any motion that may have occurred within the source area 215 between the times that the ambient images 210 were acquired. For purposes of discussion, a recently acquired ambient image 210 can be referred to as a current ambient image 210-1 (“current image 210-1”), while a previously acquired ambient image 210 can be referred to as a prior ambient image 210-2, a previous ambient image 210-2, or a past ambient image 210-2 (“previous image 210-2”). The current image 210-1 and the previous image 210-2 can represent any set of ambient images 210 acquired by the acquisition subsystem 310.

The isolation subsystem 320 can be configured to access the current image 210-1 and the previous image 210-2. For example, the isolation subsystem 320 can include an image storage 410. The image storage 410 can include any memory device capable of storing the acquired ambient images 210, including but not limited to a buffer, a cache, random access memory (RAM), a hard disk, and any other type of computer-readable medium. In an exemplary embodiment, the image storage 410 temporarily stores the ambient images 210 so that at least the current image 210-1 and the previous image 210-2 can be accessed and subjected to the segmentation process. In another embodiment, the ambient images 210 are stored in a more permanent manner for later access.

B. Histogram Module

The isolation subsystem 320 can include a histogram module 430. The histogram module 430 can access the acquired ambient images 210 from the image storage 410. The histogram module 430 is configured to generate the joint histogram 220 based on two ambient images 210, such as the current image 210-1 and the previous image 210-2. The joint histogram 220 readily identifies information that is unchanged between the current images 210-1 and the previous image 210-2. The capability of the joint histogram 220 to identify unchanged information between images is discussed in detail below.

The unchanged information between the images 210-1, 210-2 can be referred to as mutual information 435 (also referred to as “motionless data 435” or “motionless information 435”). Mutual information 435 is useful for identifying a lack of motion between the current image 210-1 and the previous image 210-2. Mutual information 435 should be understood to include congruent pixel values that are shared by spatially corresponding pixels of the images 210-1, 210-2. For example, a pixel of the current image 210-1 and its spatially corresponding pixel in the previous image 210-2 can be referred to as a “corresponding pixel pair.” When pixels of a corresponding pixel pair share a common value for a certain pixel characteristic, e.g., grayscale luminosity, the corresponding pixel pair can be said to share mutual information 435. The mutual information 435 between a corresponding pixel pair is representative of a lack of motion during the time interval between acquisition of the previous image 210-2 and acquisition of the current image 210-1.

Mutual information 435 can be defined by any of Equations 1, 2, and 3, in which I(A;B) represents mutual information of an image A and an image B, H(A) represents an entropy of image A, H(B) represents an entropy of image B, H(A,B) represents a joint entropy of images A and B, H(A|B) represents a conditional entropy of images A and B, p(a) represents the individual distribution of the data set of image A, p(b) represents the individual distribution of the data set of image B, and p(a,b) represents the joint distribution of the data sets of images A and B. In a preferred embodiment, Equation 3 is used to calculate the mutual information 435.
I(A; B)=H(B)−H(B|A)=H(A)−H(A|B) Equation 1
I(A; B)=H(A)+H(B)−H(A, B) Equation 2

$$Equation 3 \text{:} I ( A ; B ) = {\sum }_{a , b} p ( a , b ) \cdot log ( \frac{p ( a , b )}{p ( a ) p ( b )} )$$

The entropy H(A), joint entropy H(A,B), and conditional entropy H(A|B) can be calculated using Equations 4, 5, and 6, respectively. In Equations 4, 5, and 6, p(i), p(i,j), and p(i|j) represent the individual, joint, and conditional density functions, respectively.

$$Equation 4 \text{:} H ( A ) = - {\sum }_{i ε A} p ( i ) \cdot log [ p ( i ) ]$$

$$Equation 5 \text{:} H ( A , B ) = - {\sum }_{i ε A , j ε B} p ( i , j ) \cdot log [ p ( i , j ) ]$$

$$Equation 6 \text{:} H ( A \vert B ) = - {\sum }_{i ε A , j ε B} p ( i \vert j ) \cdot log [ p ( i \vert j ) ]$$

For imaging applications, the joint density function can be easily defined using the joint histogram 220. Accordingly, the system 100 uses the joint histogram 220 to indicate the mutual information 435 shared by the current image 210-1 and the previous image 210-2.

The histogram module 430 can generate the joint histogram 220 in a number of ways. In a preferred embodiment, the histogram module 430 generates the joint histogram 220 by processing each corresponding pixel pair of the images 210-1, 210-2. The histogram module 430 can be configured to take each pixel in the current image 210-2 and for the spatially corresponding pixel in the previous image 210-2, take the grayscale value (or other pixel characteristic value) of each of the two pixels and increment the joint histogram 220 at a location identified by the grayscale values.

Locations within the joint histogram 220 can be referred to as histogram cells. The histogram cells include the number of corresponding pixel pairs in the images 210-1, 210-2 that are described by a particular combination of characteristics. For example, in a preferred embodiment, a histogram cell identified by location (255, 255) will include the number of corresponding pixel pairs that have pixels sharing mutual information 345 of common grayscale values of 255.

The histogram cells can also include data identifying the associated pixel addresses in the current image 210-1 and/or the previous image 210-2. For example, when a histogram cell is incremented for a corresponding pixel pair, location information for the pixels in the images 210-1, 210-2 can be recorded for that same histogram cell. In a preferred embodiment, linked lists are used to associate pixel addresses in the images 210-1, 210-2 with particular histogram cells. By associating pixel addresses with histogram cells, the system 100 can process the pixels of the images 210-1, 210-2 based on the information referenced by the histogram cells of the joint histogram 220. This feature will be discussed in greater detail below.

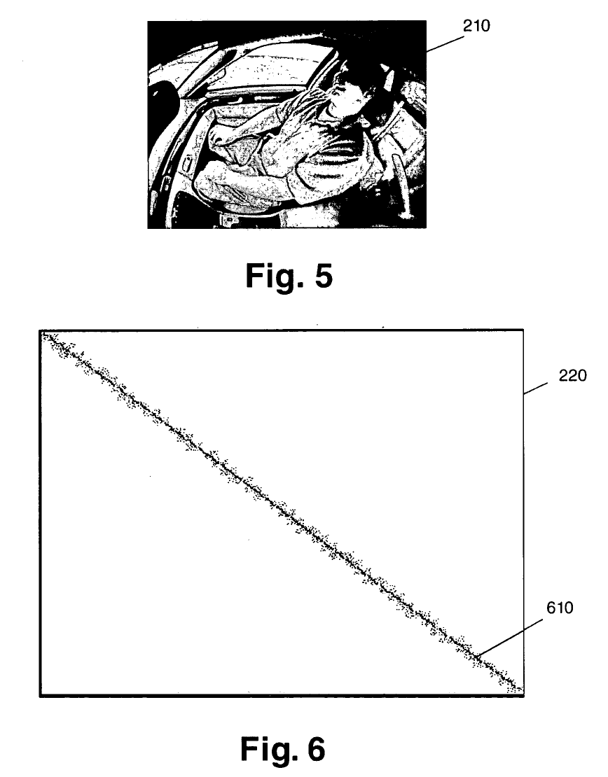

The joint histogram 220 indicates the mutual information 435 shared by the images 210-1, 210-2 as a diagonal line of unity slope and intercept zero. For example, FIG. 5 illustrates a particular ambient image 210. When the image 210 is compared with itself to generate a related joint histogram 220, the joint histogram 220 shown in FIG. 6 will result. As shown in FIG. 6, a diagonal line 610 of unity slope generally intersects opposite corners of the joint histogram 220. The diagonal line 610 represents the corresponding pixel pairs of the images 210-1, 210-2 that share mutual information 435. Because the joint histogram 220 shown in FIG. 6 represents of a comparison the image 210 of FIG. 6 compared with itself (identical images), all corresponding pixel pair values have congruent pixel characteristic values and fall on the diagonal line 610.

The axes of the joint histogram 220 comprise ranges of possible values of pixel characteristics of the images 210 being compared. Assuming the grayscale values of the current image 210-1 and the previous image 210-2 are being compared, one axis can represent the range of grayscale values of the current image 210-1, while the other axis represents the range of grayscale values of the previous image 210-2. In a preferred embodiment, the range of pixel values for each image 210 being compared is the same.

With the axes of the joint histogram 220 representing ranges of pixel values, the diagonal line 610 indicates instances where corresponding pixels share a common pixel value. In FIG. 6, the diagonal line 610 can be said to indicate instances where a value of a particular pixel of the current image 210-1 equals the negative value of the spatially corresponding pixel of the previous image 210-2. Thus, the diagonal line 610 can be identified by its unity slope and zero intercept.

C. Mutual Information Removal Module

By using the joint histogram 220 to indicate mutual information 435, the system 100 can quickly and accurately remove mutual information 435 representing motionless pixels from the current image 210-1. A mutual information removal module 440 can access the joint histogram 220 to identify mutual information 435. The mutual information removal module 440 may traverse the histogram cells on the diagonal line 610. In some embodiments, histogram cells up to a predefined distance away from the diagonal line 610 can be identified by the mutual information removal module 440 as containing a suitable amount of mutual information 435, as to be removed from the image 210-1. This allows the system 100 to set a tolerance level within which values of corresponding pixel pairs will be treated as mutual information 435 up to a certain predetermined threshold difference between the values.

The mutual information removal module 440 can then remove the pixels associated with the identified mutual information 435 from the current image 210-1 and/or the previous image 210-2. In an exemplary embodiment, the mutual information removal module 440 provides for removing each pixel from the current image 210-1 that is identified by the joint histogram 220 as sharing mutual information 435 with the spatially corresponding pixel in the previous image 210-2. To remove the identified pixels from the current image 210-1, the mutual information removal module 440 may set the grayscale values of the pixels to zero. In a preferred embodiment, the linked lists discussed above are used to “zero out” the pixel values at the pixel addresses associated with the histogram cells on the diagonal line 610.

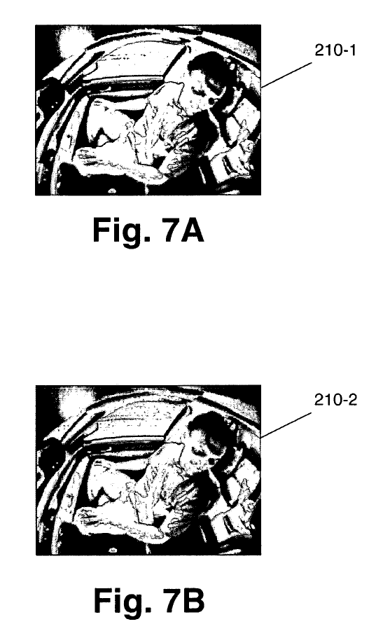

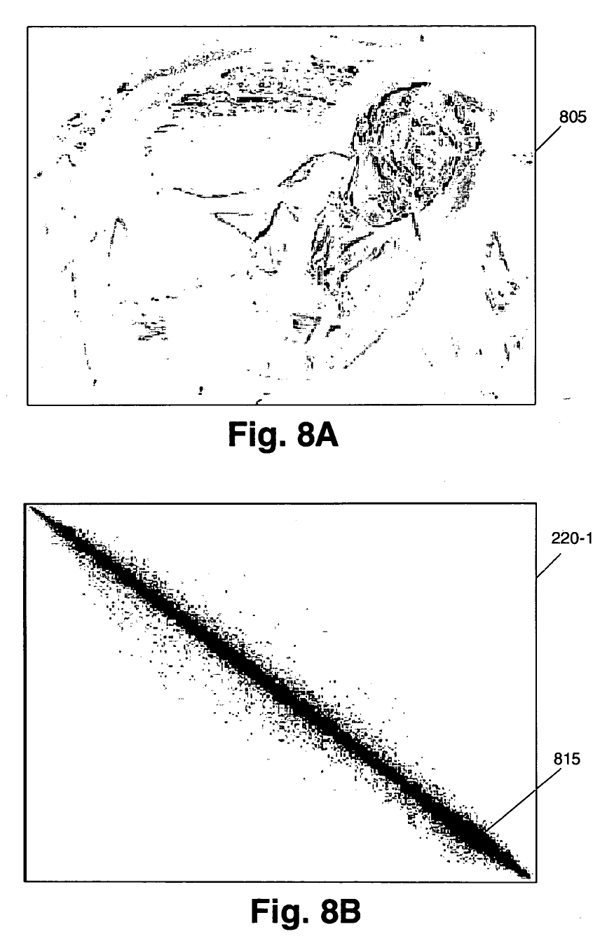

FIGS. 7A-B are examples of particular ambient images 210 that can be compared to each other for identifying mutual information 435. FIG. 7A shows the current image 210-1, while FIG. 7B shows the previous image 210-2. The current image 210-1 of FIG. 7A indicates that some motion has occurred since the acquisition of the previous image 210-2 of FIG. 7B. FIG. 8A is a difference image 805 showing motion between the images 210-1, 210-2 of FIGS. 7A-B. The lighter pixels shown in FIG. 8A indicate areas of motion between the images 210-1, 210-2.

The histogram module 430 can generate a related joint histogram 220-1 for the images 210-1, 210-2 of FIGS. 7A-B, which joint histogram 220-1 is shown in FIG. 8B. Motion between the images 210-1, 210-2 of FIGS. 7A-B is indicated by blurred area 815. The blurred area 815 comprises pixels not on the unity slope line running through the blurred area 815. These pixels are shown in FIG. 8B as the blurred area 815 positioned along the outskirts of the unity slope and zero intercept line. The isolation subsystem 320 can identify the unity slope line to remove mutual associate with the blurred area 815. This allows the system 100 to easily remove unchanged information from the current image 210-1, while leaving the motion-based information to be isolated into the segmented image 225.

D. Illumination Removal Module

The system 100 can also provide for removing illumination effects from the current image 210-1. Illumination effects are generally understood to be changes to luminosity values in the ambient image 210 that are generally caused by changes in externally generated lighting or shading, and not due to changes in the object in the image 210-1 itself. The joint histogram 220 can be used to readily identify the effects of illumination changes in the current image 210-1, including the effects of illumination on the mutual information 435.

The illumination changes on an image have been modeled in the art as consisting of multiplicative and/or additive illumination. Additive illumination can be used to model the simple addition of more external light, while multiplicative illumination can model a change in the direction of the light source which causes a change in the amount of light reflected from the object.

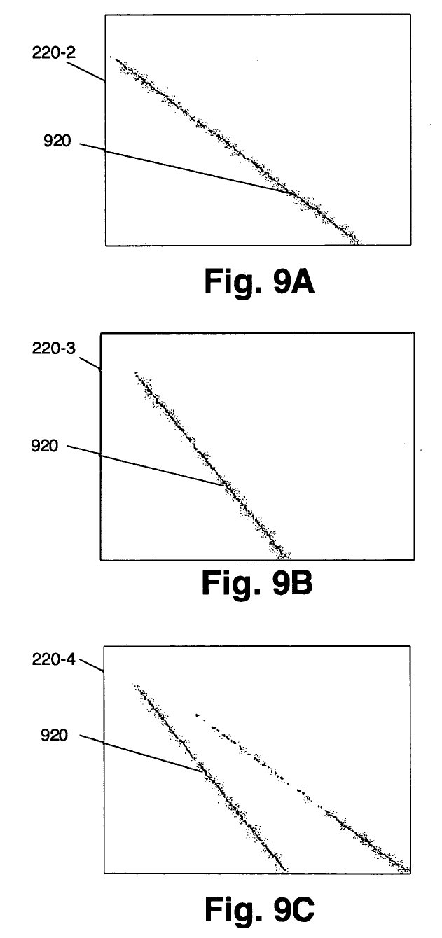

FIGS. 9A-C show respective joint histograms 435-2, 435-3, 435-4 that indicate changes that several types of illumination effects rendered on mutual information 435. FIG. 9A shows joint histogram 220-2, which is representative of a particular ambient image 210 compared with a version of itself with additive illumination. FIG. 9B shows joint histogram 220-3, which is representative of a particular ambient image 210 compared with a version of itself with multiplicative illumination. FIG. 9C shows joint histogram 220-4, which is representative of a particular ambient image 210 compared with a version of itself with only a region with multiplicative illumination. As shown in these figures, illumination effects tend to be represented as distinct lines 920 in the joint histograms 435-2, 435-3, 435-4. In other words, illumination changes tend to affect the joint histogram's 435 representation of mutual information 435 by causing the slope and Y-intercept of the diagonal line 610 to change. When regions of the ambient image 210 are affected differently by illumination changes, multiple lines 920 can be produced in the joint histogram 220-4. However, the illumination-affected 920 lines remain well structured with no dispersion or distortion. This allows the system 100 to identify and remove pixels associated with the distinct lines 920.

An illumination removal module 450 can provide for removing illumination effects from the ambient image 210 The illumination removal module 450 is able to access the current image 210-1 and the joint histogram 220. The illumination removal module 450 then identifies the distinct lines 920 in the joint histogram 220 that may be caused by illumination effects. A line detection application or process can be performed to identify any distinct lines 920 that are not in a cloud, but have a clear background. A number of line detection processes known in the art can be used.

Illumination effects can then be removed from the current image 210-1. Similar to the removal of mutual information 435 from the current image 210-1, pixels associated with the detected distinct lines 920 of the joint histogram 220 can be removed from the current image 210-1. For example, pixel addresses associated with histogram cells on the distinct lines 920 can be identified and their grayscale values set to zero using the linked lists of the histogram cells, since the distinct lines 920 will clearly correspond to illumination changes and not motion.

The illumination removal module 450 ensures that the system 100 can remove pixels that have been affected by illumination changes without removing pixels that have been affected by motion. The system 100 can use the joint histogram 220 to easily and accurately distinguish and separate occupant motion from illumination effects. As mentioned above, the joint histogram 220 indicates mutual information 435, including mutual information 435 affected by illumination, with the diagonal line 610 and distinct straight lines 920, respectively. Contrastingly, the joint histogram 220 indicates occupant motion with generally non-linear pixels, especially blurred areas bordering distinct lines, such as the blurred area 815 shown in FIG. 8B. For purposes of pixel removal, the system 100 should be configured to identify clean straight lines in the joint histogram 220, while not identifying blurred line edges. This provides great immunity to illumination variations that exist between ambient images 210.

Further, the segmentation process 320 provides for improved image processing speeds. By using the joint histogram 220, the system 100 is able to quickly identify pixels not associated with motion. The system 100 can then remove the pixels not associated with motion (mutual information 435 and illumination effects) from the ambient image 210 so that subsequent image processing steps may focus on the pixels affected by motion.

E. Clean-Up Module

Returning now to FIG. 4, once removal of the mutual information 435 and illumination effects has been performed, the current image 210-1 contains values only for pixels affected by motion. The isolation subsystem 320 can clean the current image 210-1 even further to remove undesirable pixels that have been affected by motion. A clean-up module 460 can be configured to clean the current image 210-1. The cleanup module 460 can provide various cleanup operations, including separating occupant pixels from environmental pixels (also referred to as “non-occupant pixels”). Any image processing techniques known in the art or disclosed in the patent applications incorporated by reference in their entirety can be used to clean the current image 210-1 after mutual information 435 and illumination effects have been removed. For example, a morphological closing application can be used to remove many small regions of the current image 210-1. In the context of a vehicle safety restraint application embodiment of the system 100, the clean-up module 460 can remove pixels representative of environmental motion, e.g., motion seen out a window, from the current image 210-1.

F. Ellipse Fitting Module

The system 100 can further segment the current image 210-1 by isolating a region of the current image 210-1 in preparation for further processing by the safety restraint deployment application 145. Many occupant characteristics are not incorporated into safety restraint deployment decisions. Key characteristics for deployment purposes typically relate to position and motion characteristics. Thus, there is no reason to subject the entire segmented current image 210-1 to subsequent processing.

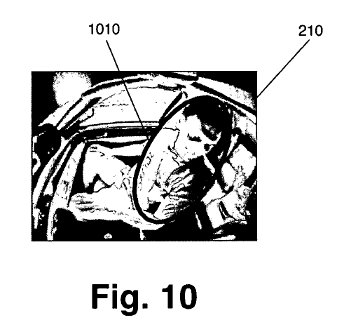

The isolation subsystem 320 can include an ellipse fitting module 470 configured to identify and define a particular portion of the current image 210-1 to be used for subsequent processing. For example, the ellipse fitting module 470 can fit an elliptical shape to a portion of the current image 210-1 that is helpful for indicating the position of the occupant 105 in the vehicle. FIG. 10 shows an example of a bounding ellipse 1010 fitted about an occupant area of a particular ambient image 210. Alternatively, the isolation subsystem 320 can use other geometric shapes or configurations of points to define particular regions of the segmented image 225.

Parameters of the bounding ellipse 1010 can be calculated using a number of different techniques. In a preferred embodiment, the parameters are calculated from the central moments of the segmented image 225 according to Equations 5-10, in which m₀₀ represents the central moments up to the second order, N represents the number of pixels along on axis of the current image 210-1, M represents the number of pixels along the other axis of the current image 210-1, i represents the row index of the pixel, j represents the column index of the pixel, and I(i,j) represents the actual value of the pixel at the location (i,j). Also, μₓ represents the column location of the centroid, μ_{y} represents the row location of the centroid, Σₓₓ represents the variance of the image in the column (x) direction, Σ_{xy} represents the co-variance of the image in the column (x) and row (y) direction, and Σ_{yy} represents the variance of the image in the row (y) direction.

$$Equation 5 \text{:} {m}_{00} = {\sum }_{i = 1}^{N} {\sum }_{j = 1}^{M} I ( i , j )$$

$$Equation 6 \text{:} {μ}_{x} = \frac{1}{{m}_{00}} {\sum }_{i = 1}^{N} {\sum }_{j = 1}^{M} I ( i , j ) \cdot x$$

$$Equation 7 \text{:} {μ}_{y} = \frac{1}{{m}_{00}} {\sum }_{i = 1}^{N} {\sum }_{j = 1}^{M} I ( i , j ) \cdot y$$

$$Equation 8 \text{:} {\sum }_{xx} = \frac{1}{{m}_{00}} {\sum }_{i = 1}^{N} {\sum }_{j = 1}^{M} I ( i , j ) \cdot {( x - {μ}_{x} )}^{2}$$

$$Equation 9 \text{:} {\sum }_{yy} = \frac{1}{{m}_{00}} {\sum }_{i = 1}^{N} {\sum }_{j = 1}^{M} I ( i , j ) \cdot ( x - {μ}_{x} ) ( y - {μ}_{y} )$$

$$Equation 10 \text{:} {\sum }_{yy} = \frac{1}{{m}_{00}} {\sum }_{i = 1}^{N} {\sum }_{j = 1}^{M} I ( i , j ) \cdot {( y - {μ}_{y} )}^{2}$$

The values determined from Equations 5-10 can then be used to determine the parameters of the bounding ellipse 1010 according to Equations 11-15.
centroidₓ=μₓ Equation 11
centroid_{y}=μ_{y} Equation 12

$$Equation 13 \text{:} {major}_{—} axis = \frac{1}{2} \cdot ( {\sum }_{xx} + {\sum }_{yy} ) + \frac{1}{2} \cdot {( {\sum }_{yy}^{2} + {\sum }_{xx}^{2} - 2 \cdot {\sum }_{xx} \cdot {\sum }_{yy} + 4 \cdot {\sum }_{xy}^{2} )}^{0.5}$$

$$Equation 14 \text{:} {minor}_{—} axis = \frac{1}{2} \cdot ( {\sum }_{xx} + {\sum }_{yy} ) - \frac{1}{2} \cdot {( {\sum }_{yy}^{2} + {\sum }_{xx}^{2} - 2 \cdot {\sum }_{xx} \cdot {\sum }_{yy} + 4 \cdot {\sum }_{xy}^{2} )}^{0.5}$$

Slope=α tan 2(axis1−Σₓₓ, Σ_{xy}) Equation 15

Alternatively, any shape-fitting processes described in the patent applications incorporated by reference in their entirety can be used to fit a shape to a particular region of the current image 210-1.

By performing any combination of the above removal, clean-up, and shape fitting processes, the isolation subsystem 320 produces the segmented image 225. While in a preferred embodiment, each of the above processes is executed to segment the current image 210-1, it is anticipated that the isolation subsystem 320 may produce the segmented image 225 using only a subset of the described processes. For example, the segmented image 225 can be generated by simply removing the mutual information 435 at the mutual information removal module 440. In any event, the system 100 can make the segmented images 225 available to the safety restraint deployment application 145 for use in making deployment decisions.

IV. Alternative Embodiments

While the invention has been specifically described in connection with certain specific embodiments thereof, it is to be understood that this is by way of illustration and not of limitation, and the scope of the appended claims should be construed as broadly as the prior art will permit. Given the disclosure above, one skilled in the art could implement the system 100 in a wide variety of different embodiments, including vehicle safety restraint applications, security applications, radiological applications, navigation applications, and a wide variety of different contexts, purposes, and environments.

1. A method for segmenting an image, comprising:
generating a joint histogram of a first image and a second image;
using said joint histogram to identify motionless information representative of a lack of motion between said first image and said second image; and
removing said motionless information from said second image.

2. The method of claim 1, wherein said removing motionless information comprises:
identifying pixels of said second image that are associated with said motionless information; and
clearing pixel values of said pixels.

3. The method of claim 2, wherein said identifying includes:
detecting a line of unity slop and intercept zero in said joint histogram, said line being representative of said motionless information; and
associating said line with corresponding pixel addresses of said second image.

4. The method of claim 2, wherein said clearing pixel values comprises zeroing out a value of each of said pixels.

5. The method of claim 1, wherein said generating further comprises incrementing said joint histogram at locations identified by pixel values of spatially corresponding pixels of said first image and said second image.

6. The method of claim 1, wherein said generating further comprises associating histogram cells with pixels of said second image.

7. The method of claim 1, further comprising:
using said joint histogram to identify illumination changes between said first image and said second image; and
removing said illumination changes from said second image.

8. The method of claim 7, wherein said removing illumination changes comprises:
identifying pixels of said second image that are associated with said illumination changes; and
clearing pixel values of said pixels.

9. The method of claim 8, wherein said identifying includes:
detecting distinct lines in said joint histogram, said distinct lines being representative of said illumination effects; and
determining pixel addresses in said second image, wherein said pixel addresses correspond with said distinct lines.

10. The method of claim 8, wherein said clearing pixel values comprises zeroing out a value of each of said pixels.

11. An image segmentation system for segmenting an image acquired with a sensor, comprising:
a histogram module providing for generating a joint histogram of a first image and a second image, wherein said joint histogram indicates motionless information representative of a lack of motion between said first image and said second image; and
a removal module providing for removing said motionless information indicated by said joint histogram from said second image.

12. The system of claim 11, wherein said motionless information is indicated by said joint histogram as a line of unity slope and intercept zero.

13. The system of claim 11, wherein said motionless information is indicated by said joint histogram as locations within approximately a predetermined distance of a line of unity slope and intercept zero.

14. The system of claim 11, wherein said motionless information represents congruent pixel values shared by spatially corresponding pixels of said first image and said second image.

15. The system of claim 11, wherein said histogram module provides for generating said joint histogram by incrementing said joint histogram at locations identified by pixel values of spatially corresponding pixels of said first image and said second image.

16. The system of claim 11, wherein said joint histogram is represented by a number of histogram cells, each said histogram cell being configured to indicate an associated pixel address of said second image.

17. The system of claim 16, wherein said removal module provides for removing said motionless information from said second image by:
identifying a subset of said histogram cells that are associated with said motionless information;
determining pixels of said second image that are associated with said histogram cells; and
clearing pixel values of said pixels.

18. The system of claim 17, wherein said removal module provides for clearing pixel values by zeroing out a value of each said pixel.

19. The system of claim 11, further comprising a second removal module providing for removing illumination effects indicated by said joint histogram from said second image.

20. The system of claim 19, wherein said second removal module provides for removing said illumination effects by:
detecting distinct lines in said joint histogram;
determining pixels of said second image that are associated with said distinct lines; and
clearing pixel values of said pixels.

21. The system of claim 20, wherein said second removal module zeroes out a value of each said pixel.

22. An image segmentation system for a vehicle safety restraint deployment application, comprising:
a sensor configured to acquire a plurality of images representative of an image source area, wherein said plurality of images includes a current image and a previous image;
a computer providing for:
generating a joint histogram of said current image and said previous image, wherein said joint histogram indicates motionless information representative of a lack of motion between said current image and said previous image;
removing said motionless information indicated by said joint histogram from said current image to produce a segmented image;
providing said segmented image to the safety restraint deployment system.

23. The system of claim 22, wherein said motionless information is indicated by said joint histogram as a line of unity slope and intercept zero.

24. The system of claim 22, wherein said motionless information is indicated by said joint histogram as locations within approximately a predetermined distance of a line of unity slope and intercept zero.

25. The system of claim 22, wherein said motionless information represents congruent pixel values shared by spatially corresponding pixels of said current image and said previous image.

26. The system of claim 22, wherein said computer provides for generating said joint histogram by incrementing said joint histogram at locations identified by pixel values of spatially corresponding pixels of said current image and said previous image.

27. The system of claim 22, wherein said joint histogram is represented by a number of histogram cells, each said histogram cell being configured to indicate an associated pixel address of said current image.

28. The system of claim 27, wherein said computer provides for removing said motionless information from said current image by:
identifying a subset of said histogram cells that are associated with said motionless information;
determining pixels of said current image that are associated with said histogram cells; and
clearing pixel values of said pixels.

29. The system of claim 28, wherein said computer provides for clearing pixel values by zeroing out a value of each said pixel.

30. The system of claim 22, wherein said computer further provides for removing illumination effects indicated by said joint histogram from said current image.

31. The system of claim 30, wherein said computer provides for removing said illumination effects by:
detecting distinct lines in said joint histogram;
determining pixels of said current image that are associated with said distinct lines; and
clearing pixel values of said pixels.

32. The system of claim 31, wherein said computer provides for clearing pixel values by zeroing out a value of each said pixel.

33. The system of claim 22, wherein said computer further provides for by removing regions representative of non-occupant motion from said current image.

34. The system of claim 22, wherein said computer system further provides for defining a region of said current image by fitting an elliptical shape to said region.

35. The system of claim 34, wherein said region represents an upper portion of a vehicle occupant.

36. The system of claim 22, wherein said segmented image represents a characteristic of a vehicle occupant.

37. The system of claim 22, wherein said sensor comprises a video camera for sequentially capturing said plurality of images.
